(19) United States
(12) Patent Application Publication
(10) Pub. No.: US 2008/0230186 A1
(43) Pub. Date: Sep. 25, 2008

(54) Easy Hang Cornice

(76) Inventors: Gretchen C. Briggs, Woodbridge, VA (US); Wilbert J. Briggs, Woodbridge, VA (US)

Correspondence Address: GRETCHEN BRIGGS;WILBERT J. BRIGGS, JR., 1793 PADUCAH CT., WOODBRIDGE, VA, 22191, US

(21) Appl. No.: 12/053,638

(22) Filed: Mar. 24, 2008

Related U.S. Application Data
(60) Provisional application No. 60/907,152, filed on Mar. 22, 2007.

(51) Int. Cl. E04F 10/00; B32B 38/10; D05B 23/00

(52) U.S. Cl. 160/38; 156/250; 29/428; 112/475.08

(57) ABSTRACT

A lightweight cornice with a hanging device such as sawtooth plate attached to the cornice back. The cornice assembly comprises of three sections; two side members and a top member that fits with the side members. The cornice has a fabric cover applied over the face, sides and top of the cornice structures. A hanging device is then attached to the top back area of the assembled cornice for easy mounting and dismounting. In accordance with the present invention, a lightweight cornices is provided that substantially eliminates or reduces the disadvantages associated with prior developed lightweight cornices.

### BACKGROUND AND FIELD OF INVENTION

The present invention is related to window cornices and the like. More particularly, the present invention relates to improvements to window cornices and the method for hanging them. Fabric cornice board valances are commonly used in the prior art, but there are noted disadvantages in there use. Such valances are usually made custom, resulting in extensive delivery wait time. These valances can be expensive. Last, but most notable, fabric cornices are often heavy, requiring professional installation, thus contributing to the cost.

In general, a cornice is a decorative window top treatment, more particularly a rigid board with a fabric arrangement covering it. The prior art in such technical field of window coverings characterizes fabric window cornice as either “hard” or “soft” valances. The “hard” window cornice uses a solid frame which is made of rigid material and which has front, top and side members of varying lengths, to which fabric, batting and lining is attached which follows the shape and form of the solid frame. The “soft” window cornice uses a open frame which is made of rigid material and which has top and on many occasions but not always side members of varying lengths, to which sewn to shape fabric is attached by common staples to the open frame.

The prior art is replete with examples of window cornices, which are made in a variety of rigid materials that are supported by wall brackets affixed to the cornice. See for example U.S. Pat. No. 3,996,987 issued to Rodriquez on Dec. 14, 1976. It has been known more recent in the prior art that window cornices are made of various materials such as foam, paperboard, polystyrene board and cardboard. See, for example U.S. Pat. No. 5,505,245 issued to Badalament on Apr. 9, 1996, U.S. Pat. No. 6,085,821 issued to Roberts on Jul. 11, 2000, U.S. Pat. No. 5,484,006 issued to Walker on Jan. 16, 1996. Lightweight cornices such as the aforementioned rely on devices such as Velcro (hook and loop) fasteners, adhesives, brackets and curtain rods as a means of support. In the prior art several lightweight cornices are distributed to consumers as do-it-yourself kits. In addition to installation, user assembly and application of the fabric cover is required. See, for example, U.S. Pat. No. 6,085,821 issued to Roberts on Jul. 11, 2000 and U.S. Pat. No. 6,371,190B1 issued to Owens on Apr. 16, 2002.

The invention further relates to the prior art of support devices. Since time in memoriam, a number of techniques have been employed to hang a picture or wall object. See for example, U.S. Pat. No. 4,039,138 issued to Einhorn on Aug. 2, 1977, U.S. Pat. No. 6,880,795B1 issued to Haynes III on Apr. 19, 2005. One such technique employs a serrated plate, also known as a sawtooth plate (hanger) attached to the upper back area of a frame of the picture or wall object. The serrated plates are typically used in pairs. The technique employs a nail or the like secured to a wall surface. The nail engages one of the serrations of the saw tooth plate for support of the picture or wall object. It would be desirable to provide a cornice in the present application that recognizes the advantages of the features contributed by the two prior arts.

Against the foregoing background, it is the primary object of the present invention to provide a more practical use of a lightweight fabric cornice. That can be easily installed and removed and reinstalled. It is another object of the invention to provide a fabric cornice that can be used as a decorative accessory in a variety of applications such as window treatments, bed canopy, door way cornice, etc. It is yet another object of the invention to provide versatility, such as varying widths, contours and fabric cover choices.

It is still another object of the invention to be used in combination with other window covering such as drapery panels, blinds, shades, etc.

It is yet still another object of the invention to provide a cornice that requires limited skill to install.

Accordingly, the present invention provides a cornice, which interfaces with the prior art of lightweight cornice assemblies and the prior art of support devices such as sawtooth hangers, for an improved means of window treatment.

### SUMMARY OF THE INVENTION

This invention combines a lightweight cornice with an ordinary sawtooth plate. The cornice structure is a frame made of a rigid material, covered with fabric, which is attached with common staples. A pair of sawtooth plates (hangers) is affixed to the cornice frame back after fabric cover is attached.

Using the sawtooth hangers embodying the present invention, a light weight cornice made with a rigid frame can be hung quickly and easily on a nail or the like, attached to a vertical wall structure. This requires limited tool skill.

The contributing element of the foregoing lightweight cornice in brief summary comprises of two articles:
[I] A cornice frame with built in leg support eliminating the need for additional components.
[II] Sawtooth hanging device, which adds no additional weight to the cornice, yet is a practical device with flexibility in adjustment to secure the cornice to a vertical wall structure.
[III] Removable tabs attached to the hanging device aid in providing easier installation.

In summary the present invention is to provide a decorative accessory which can be inexpensively manufactured, mass marketed and distributed using the sawtooth picture hanger embodying the present invention, the cornice structure can be easily mounted or dismounted eliminating the need for a professional installer.

### BRIEF DESCRIPTION OF THE DRAWINGS

FIG. 1 is a perspective view of the cornice frame perimeter of the present invention.

FIG. 2 is a front and side plane view of the assembled fabric cornice according to the present invention with the fabric in place.

FIG. 3 is a top elevation view of the back side of present invention assembled with fabric and the sawtooth hangers and removable tabs in place.

FIGS. 4a through 4f are additional elevation views of decorative arrangements that utilize the cornice frame of the present invention with fabric in place.

### DETAILED DESCRIPTION OF THE INVENTION

The present invention offers significant advantages in the prior art of window treatments. The invention presents a simple solution to easily mount (or dismount) a lightweight cornice. Referring to the FIGURES, the cornice members are configured to allow easy assembly in manufacturing and to maintain its light weight. Various members of rigid material are configured to form the cornice frame. The members are also configured for attachment of a fabric cover. A mounting member is affixed to the cornice frame top back permitting easy installation. Other objects, features and advantages of the invention will become apparent from a consideration of the following detailed description and the accompanying drawings. It provides for a moderate price, lightweight easy mount and dismount cornice box. With few components the cornice box can be manufactured and distributed in less time with less materials.

Throughout the following description, like numerals are used to reference the same elements of the present invention shown in multiple figures thereof.

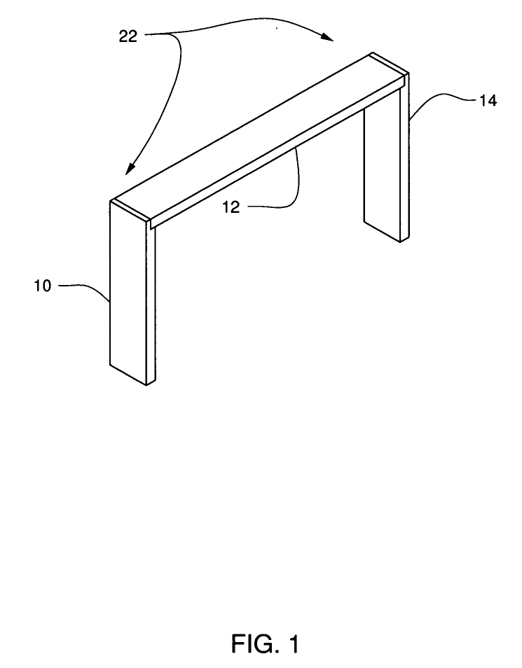

FIG. 1 is an illustration of the cornice frame 22 assembly with members 10, 12 and 14, but without the decorative fabric. Referring to the invention in more detail FIG. 1 illustrates assembly of rigid light weight material such as pine board. Board 12 assemblies are affixed to members 10 and 14 by screws, or nails, although other affixing means such as staples or glue might be used. It is to be understood that pine board 10, 12 and 14 is strong and light weight.

Board 10 and 14, as part of the cornice frame 21 assembly is the leg support members for the cornice frame 22. Board 10 and 14 is cut one-half inch (½″) from the top. Board 12 is dimensioned to interconnect on the members 10 and 14. The notched fit and attachment of boards 10 and 14 to board 12 provides built-in support, therefore this support system does not add additional materials or weight to the cornice structure 21. The length of the board 12 is forty and one-half inches (40½″). The length of board of 10 and 14 are eighteen inches (18″). The width of the boards 10, 12 and 14 are three and one half inches (3½″) and three quarters inch (¾″) thick. The dimensions may vary where, for whatever reason, it is desired to have a longer or narrower cornice board. The members 10, 12, and 14 are favorable for perspective invention for the ability to attach fabric to cornice frame 22.

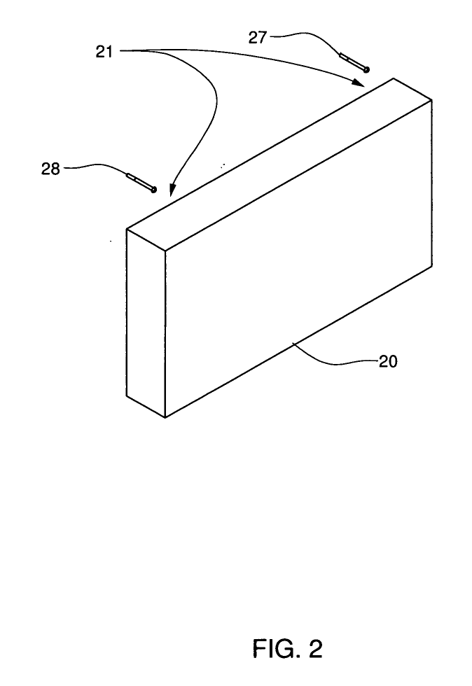

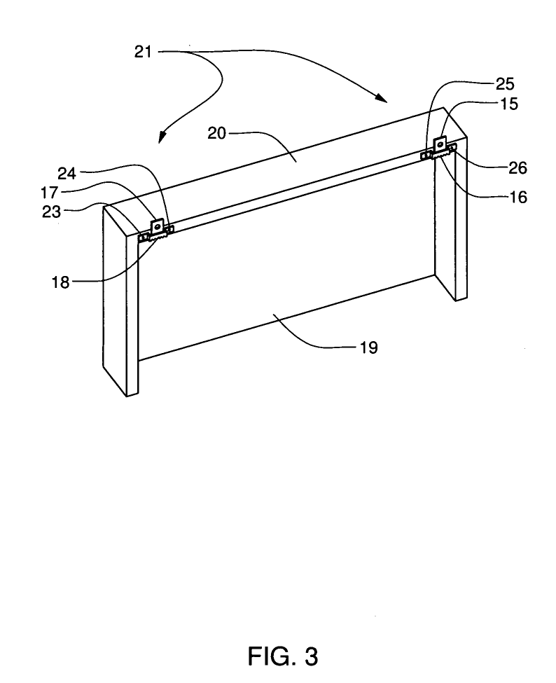

The construction detail of the invention in FIG. 2 is a cornice frame assembled and fabric 20 attached with staples. Fabric 20 is attached to lining 19 (shown in FIG. 3) to protect fabric and deflect light, then sewn in the shape therefore. Fabric 20 is wrapped from board 10 to board 14 then wrapped over and under board 12 with ends concealed. Commonly cornice construction includes padding, fabric and lining. Eliminating padding from perspective invention reduces weight.

Further detail in FIG. 3 reference the method for hanging the fabric cornice 21. Members 16 and 18 are sawtooth hangers attached over fabric 20 and embedded into member 12. Members 16 and 18 are two and one-quarter inch (2¼″) in length. Members 16 and 18 are spaced one inch (1″) from end of member 12 on either side. Members 16 and 18 are affixed to the assembled cornice frame 22 by nails and are representative of any of a number of different types of fastening means such as screws, staples or other suitable nails. When dimensions vary and board length is extended beyond forty-eight inches (48″), a third hanger such as member 16 and 18 will be affixed to board 12. The members 16 and 18, as shown in FIG. 3 rest on nails 27 and 28 in FIG. 2 extended from a vertical wall surface. Members 15 and 17 are removable tabs. Members 15 and 17 are affixed to members 16 and 18 here unto aide the position for placement of affixing any suitable nail for fastening to wall surface. The hole in the center of members 15 and 17 allows for marking the position of members 16 and 18 on the wall surface for placement of the nail to which members 16 and 18 will be secured. Members 15 and 17 may be removed and discarded.

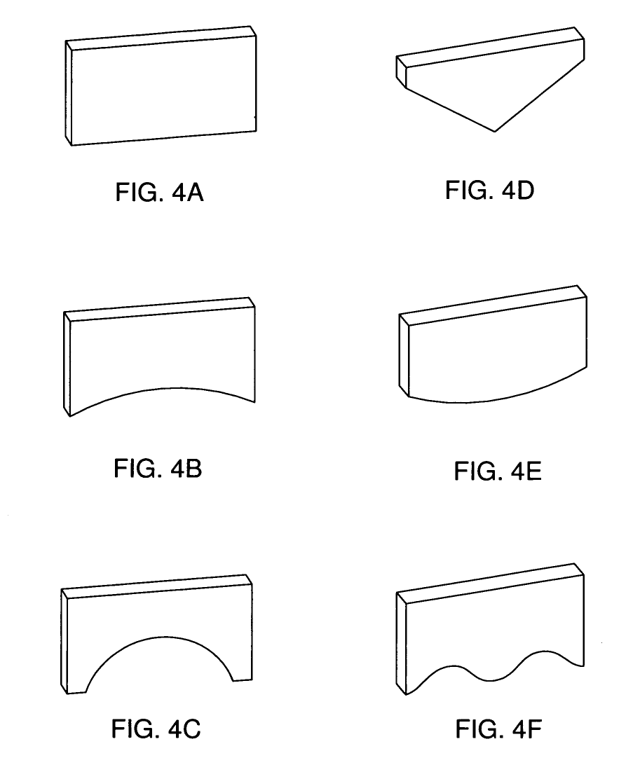

In more detail, still referring to the invention in FIG. 4a through 4f are additional views of decorative arrangements. The overall weight of the cornice may vary, whereas the desired fabric choice weight may vary. FIG. 4a through 4f is a representation of any of a number of different styles you may attain with numerous fabrics.

While foregoing written description of the invention enables one of ordinary skill to use, with reverence to particular embodiments thereof, it will be appreciated that in some instances some features of the invention will be employed without a corresponding use of other features described her in. The invention should therefore not be limited by the above described embodiment, method and examples, but by all embodiments and methods within the scope and spirit of the invention as set forth.

### RELATED U.S. PATENT DOCUMENTS

U.S. Pat. No. Des. 393,771
U.S. Pat. No. D472,401S
U.S. Pat. No. D486,025S
U.S. Pat. No. D524,452S
US 2006/0272239A1
U.S. Pat. No. 3,996,987
U.S. Pat. No. 4,039,138
U.S. Pat. No. 4,496,128
U.S. Pat. No. 4,821,349
U.S. Pat. No. 4,903,394
U.S. Pat. No. 4,966,218
U.S. Pat. No. 5,042,548
U.S. Pat. No. 5,062,463
U.S. Pat. No. 5,067,542
U.S. Pat. No. 5,159,965
U.S. Pat. No. 5,217,784
U.S. Pat. No. 5,484,006
U.S. Pat. No. 5,503,209
U.S. Pat. No. 5,505,245
U.S. Pat. No. 5,597,025
U.S. Pat. No. 5,791,625
U.S. Pat. No. 5,967,213
U.S. Pat. No. 6,085,821
U.S. Pat. No. 6,131,867
U.S. Pat. No. 6,152,204
U.S. Pat. No. 6,315,026
U.S. Pat. No. 6,371,190
U.S. Pat. No. 6,405,466B1
U.S. Pat. No. 6,655,439B2
U.S. Pat. No. 6,659,154
U.S. Pat. No. 6,672,359
U.S. Pat. No. 6,732,783
U.S. Pat. No. 6,877,545
U.S. Pat. No. 6,880,795B1
U.S. Pat. No. 6,931,735
U.S. Pat. No. 7,025,320B2
U.S. Pat. No. 7,134,470
U.S. Pat. No. 7,201,357B2
U.S. Pat. No. 7,216,686B2
U.S. Pat. No. 7,216,841B2

The present inventive lightweight cornice is intended to be manufactured, mass marketed and distributed to the general public. It can be utilized and installed with relative ease of someone with limited tool skill. Although only a few embodiments of the present inventions have been described in detail in this disclosure many modifications are possible (e.g. variation in sizes, dimension, structures, shapes, profiles, mounting arrangements, colors, use of materials, etc.) without departing from the advantages of the subject matter recited. It should also be noted that the lightweight cornice might be used in association with a wide variety of other applications (e.g. frames, bed canopies, door-ways, etc.). The order of sequence of any process or method steps can be varied or re-sequenced according to alternative embodiments. Having thus described the invention with particular reference to the preferred forms thereof, it will be obvious that various changes and modifications can be made therein without departing from the spirit and scope of the present invention as defined by the appended claims.

What is claimed is:

1. A fabric cornice board of light weight rigid board material, has easy assembly, hangs on a vertical wall surface from a hanging device. The method of construction is as follows:

2. Assembly of first and second side members of a lightweight rigid board as claimed in claim 1 each having inside and outside surfaces and top and bottom edges. The top edges of the first and second side members are cut (using an ordinary cutting device) one-half inch deep and three eighths inch across into the rigid board revealing a notch.

3. A top member of the lightweight rigid board as claimed in claim 1, having top and bottom edges.

4. Adhesive and nails join the first and second side members as claimed in claim 2 to the top member as claimed in claim 3 with the first and second side members vertical and parallel to each other spaced apart and the top member affixed to the side members resting within the notch as claimed in claim 2 on either side of the first and second side members.

5. A fabric cover is cut to a desired shape and sewn to an attached lining that is cut to equivalent desired shape.

6. A fabric cover assembly as claimed in claim 5 is attached to cornice board assembly as claimed in claim 4, arranged and wrapped from inside first side member to second side member as claimed in claim 2, forming a front fabric panel with excess fabric on top wrapped over top and inside top member as claimed in claim 3 of cornice assembly.

7. Fabric cover as claimed in claim 5 is secured with staples to inside far edge of first, second and top member of cornice assembly as claimed in claim 4.

8. A hanging device such as a sawtooth plate is attached to the back of the fabric covered cornice assembly as claimed in claim 7 to secure the fabric cornice board to a vertical wall surface.

9. Sawtooth plates as claimed in claim 7 affixed to fabric covered top member as claimed in claim 6 of cornice assembly provide support for fabric cornice board to attach to vertical wall service.

10. Removable tabs are attached to sawtooth plate as claimed in claim 8 to aide in easy positioning of fabric cornice to be secured to wall structure.

11. The fabric cornice assembly comprises of few components eliminating excess and timely manufacturing.
